(19) United States
(12) Patent Application Publication
(10) Pub. No.: US 2010/0105832 A1
(43) Pub. Date: Apr. 29, 2010

(54) PROCESS FOR PREPARING AQUEOUS POLYACRYLIC ACID SOLUTIONS BY MEANS OF CONTROLLED FREE-RADICAL POLYMERIZATION

(75) Inventors: Szilard Csihony, Weinheim (DE); Tobias Stab, Frankenthal (DE); Christian Hubert Weidl, Speyer (DE)

Correspondence Address: Connolly Bove Lodge & Hutz LLP, Suite 1100, 1875 Eye Street, NW, Washington, DC, 20006, US

(73) Assignee: BASF SE, Ludwigshafen (DE)

(21) Appl. No.: 12/607,181

(22) Filed: Oct. 28, 2009

(30) Foreign Application Priority Data
Oct. 29, 2008 (EP) 08167837.7

(51) Int. Cl. C08F 2/16

(52) U.S. Cl. 524/715

(57) ABSTRACT

A process for preparing aqueous solutions of homo- or copolymers of acrylic acid with a mean molar mass Mₙ of from 500 g/mol to 10 000 g/mol by means of controlled free-radical polymerization in an aqueous medium.

The present invention relates to a process for preparing aqueous solutions of homo- or copolymers of acrylic acid with a mean molar mass Mₙ of from 500 g/mol to 10 000 g/mol by means of controlled free-radical polymerization in an aqueous medium.

The preparation of polyacrylic acid by means of controlled free-radical polymerization is known in principle. A known technique for controlled free-radical polymerization is the RAFT (Reversible Addition Fragmentation Transfer) technique.

In RAFT polymerization, sulfur-containing compounds are used to control the reaction, especially compounds of the general formula Z—C(S)—SR where Z may, for example, be a hydrocarbon group, an alcoholic group R—O— or a thiol group R—S—. The essential reaction steps of a RAFT polymerization are shown below. With regard to details, reference is made to the relevant literature, for example to “Handbook of RAFT Polymerization”, editor: Barner-Kowollik, Christopher, Wiley-VCH, Weinheim 2008.

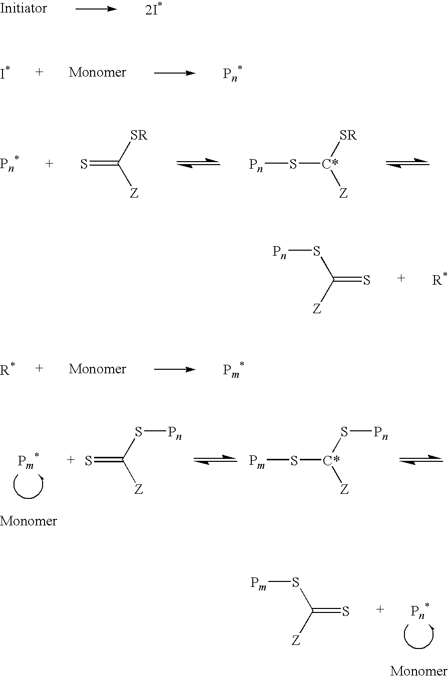

In the first step, starter free radicals are formed by the decomposition of a customary initiator for free-radical polymerization. In the second step, these starter free radicals I* react with a monomer to give a Pₙ* free radical. The Pₙ* free radical reacts in the third step with the RAFT reagent to form a more or less stable intermediate free radical. This has two possible further reactions: firstly, it can react in the backward direction and release the Pₙ* free radical again. Secondly, it can also release the R radical as an R* free radical. The R* free radical released is in turn capable of starting a new polymer chain by reacting with the monomer to give the species Pₘ*. The species Pₘ* and Pₙ* have the same reactivity with regard to the reaction with further monomers, but also with the RAFT reagent. This gives rise to an equilibrium between the transition free radical species and the two free radicals Pₙ* and Pₘ*. The establishment of this equilibrium is responsible for the control of the polymerization. Pₙ* and Pₘ* free radicals released in each case can react with further monomers to extend the chain, but also react very rapidly again with the RAFT reagent.

The application of RAFT technology to the polymerization of acrylic acid is known in principle.

EP 910 587 B1 discloses the polymerization of a multitude of different ethylenically unsaturated monomers using particular sulfur compounds, for example dithiocarboxylic acid derivatives or trithiocarbonic acid derivatives. One example describes polymerization of acrylic acid using 1-phenylethyl dithiobenzoate in dimethylformamide as a solvent. This forms polyacrylic acid with a mean molar mass Mₙ of 13 792 g/mol and a polydispersity M_{w}/Mₙ of 1.23.

EP 1 255 731 B1 discloses symmetric trithiocarbonic acid derivatives substituted by carboxyl groups and the use thereof for controlled free-radical polymerization. The document mentions the possibility of polymerizing acrylic acid, but not polymerization in water.

US 2007/0179262 discloses a process for preparing polyacrylic acid or copolymers of acrylic acid with other water-soluble comonomers using symmetric trithiocarbonic acid derivatives substituted by carboxyl groups.

U.S. Pat. No. 6,153,705 discloses, in example 2.25, the preparation of polyacrylic acid by means of controlled free-radical polymerization of acrylic acid in an aqueous medium using (O-isopropylxanthyl)valeronitrile. The reaction is performed by mixing all components with one another and heating them to 70° C. Before the reaction, the acrylic acid is neutralized to a pH of from 6 to 7. According to the conditions, polyacrylic acid forms with a mean molar mass Mₙ of from 8900 g/mol to 14 800 g/mol, and a polydispersity M_{w}/Mₙ of from 1.4 to 1.7.

US 2004/0097674 discloses a process for preparing polyacrylic acid or copolymers of acrylic acid with other water-soluble comonomers using a transfer agent of the general formula R—X—C(S)—S—R′ where X may be S or O, and R and R′ may each be a large number of different radicals, especially aromatic radicals. The reaction is performed in such a way that a “true” polymolecularity index IPᵥ of less than 2 at a mean molar mass Mₙ of more than 1000 g/mol is obtained at the same time, and, moreover, no gel occurs in the course of polymerization. In the examples, predominantly alcohols are used as solvents; in two examples, polymerization is also effected in aqueous solution using xanthogenates substituted by two ethyl carboxylate groups.

WO 03/055919 A1 discloses a process for preparing aqueous dispersions of polymer particles, in which a dispersion composed of a continuous aqueous phase, an organic phase dispersed therein, which one or more ethylenically unsaturated monomers, and an amphiphilic RAFT reagent for stabilization of the organic phase is first provided, and the dispersion is polymerized in a second step to give the said dispersion of polymer particles. The amphiphilic RAFT reagent thus also functions as a surfactant. The preparation of aqueous solutions of homo- or copolymers of acrylic acid in aqueous medium by means of a continuous process is not described.

B. Hojjati et al., Polymer (48), 2007, 5850-5858 disclose the preparation of TiO₂-polyacrylic acid nanocomposites by means of RAFT polymerization. To this end, RAFT reagents which have a free carboxyl group which can bind coordinatively to the Ti(IV) ions on the TiO₂ surface are used. The polymerization of acrylic acid is effected using such RAFT reagents anchored on TiO₂. The polymerization is performed in methanol. The preparation of aqueous solutions of homo- or copolymers of acrylic acid in an aqueous medium by means of a continuous process is not described.

In the processes mentioned, the sulfur-containing transfer agents do not function as a catalyst but are incorporated into the polymer. This may be undesired depending on the application of the polymer. Techniques for eliminating the sulfur-containing groups from the polymers have therefore also been proposed.

US 2003/0166790 discloses a process for eliminating dithio groups by reaction with amines; US 2004/0122193 discloses a process in which the polymer is reacted with a source of free radicals and at least one organic compound with a labile hydrogen atom, and US 2007/0027266 discloses a process for oxidative elimination of the groups by means of ozone.

Polyacrylic acid or polyacrylic acid copolymers with a relatively low molar mass Mₙ can be used as dispersing assistants, for example for calcium carbonate particles. Such applications are, for example, in U.S. Pat. No. 4,509,987, U.S. Pat. No. 5,317,053, U.S. Pat. No. 7,033,428. It is also known that polyacrylic acid obtained by means of RAFT polymerization can be used as a dispersing assistant, as disclosed, for example, by J. Loiseau et al., Macromolecules 2003, 36, 3066-3077 or the already cited document US 2004/0097674. Such polyacrylic acids have a better dispersing performance than polyacrylic acid prepared by conventional methods.

The polyacrylic acids are used as dispersing assistants preferably in aqueous formulation in a concentration of from approx. 40 to 50% by weight. For economic reasons, the isolation of polyacrylic acid followed by the preparation of an appropriate formulation is uneconomic; instead, an economically viable preparation process should provide an aqueous formulation which can be used for the dispersion process without further purification or workup.

However, the RAFT polymerization of acrylic acid in aqueous solution and the prolonged storage of the resulting polymer solutions present problems in practice. Firstly, many of the RAFT reagents proposed are unsuitable for working in an aqueous solution. Moreover, the removal of the heat of reaction in the batch syntheses described presents problems when working on the industrial scale, such that the reaction can be controlled only with difficulty. Finally, the sulfur-containing transfer agents incorporated into the polyacrylic acid during the RAFT polymerization can be hydrolyzed in the course of storage to release hydrogen sulfide or other volatile sulfur compounds. As a result, the polyacrylic acid solutions gain an unpleasant, highly undesired odor.

As detailed above, methods of eliminating RAFT reagents again after the polymerization have been proposed. It has been found that the elimination of sulfur-containing groups after the RAFT polymerization of acrylic acid can have the result that the molar mass of the resulting polyacrylic acid decreases by from 30 to 40% and the polydispersity Mₙ/M_{w} of the polymer increases. While even the broadening of the distribution alone can negate the advantages of RAFT polymerization, the decrease in the molar mass in the course of deactivation makes the process controllable only with difficulty.

It was an object of the invention to provide an economically viable process for preparing aqueous polyacrylic acid solutions on the industrial scale, in which no degradation of the polymer proceeds in the course of elimination of the RAFT reagents after the polymerization.

Accordingly, a process has been found for preparing aqueous solutions of homo- or copolymers of acrylic acid and optionally water-soluble monoethylenically ethylenically unsaturated comonomers (C) in an aqueous medium, the preparation being undertaken in the presence of a sulfur-containing assistant (H) for control of the reaction, where
the amount of acrylic acid is at least 80% by weight based on the sum of all monomers together,
the number-average molar mass Mₙ of the homo- or copolymer is from 500 g/mol to 10 000 g/mol,
the polydispersity of the homo- or copolymer M_{w}/Mₙ is <2,
the concentration of the homo- or copolymer is from 20 to 60% by weight based on all constituents of the aqueous solution, and
the polymerization temperature is from 20 to 100° C.,
wherein the assistant H is an unsymmetric molecule of the general formula (I) R¹—X—C(S)—S—CR²ₙ(COOR³)ₘ, (I), and where the radicals and the indices are each defined as follows:
n, m: each independently 1 or 2, where n+m=3,
X: O or S,
R¹: a radical selected from the group of
   R^{1a} alkyl radicals selected from the group of methyl, ethyl, 1-propyl, 1-butyl and 2-methyl-1-propyl,
   R^{1b} radicals of the general formula R³OOC—(CH₂)ₒ— where o is a natural number from 1 to 4, or
   R^{1c} alkoxy radicals of the general formula R⁴—[—O—CH₂—CH₂]ₖ— where R⁴ is H or a straight-chain or branched alkyl radical having from 1 to 4 carbon atoms and k is from 1 to 10,
R²: each independently H or an alkyl radical having from 1 to 4 carbon atoms, with the proviso that not more than one R² radical is H,
R³: each independently H, a cation, methyl or ethyl,
and the process comprises the following steps:
   initially charging an aqueous solution or dispersion of the sulfur-containing assistant (H) in a temperature-controllable reaction vessel,
   heating to the desired reaction temperature,
   continuously adding a water-soluble initiator having azo groups for the thermal polymerization (In), the molar ratio of the total amount of the initiator (In) to the assistant [In]/[H] being from 1:1 to 1:100,
   continuously adding acrylic acid or salts thereof and optionally further comonomers or an aqueous solution of the monomers mentioned, the molar ratio of the monomers to the assistant [monomers]/[H] being from 5:1 to 150:1, and
   deactivating the assistant (H) bonded to the acrylic acid homo- or copolymer formed,
with the proviso that the polymerization is conducted up to a conversion of at least 99%, and that the total amount of the aqueous medium used is such that, after the process has been performed, the concentration of the homo- or copolymer is from 20 to 60% by weight based on all constituents of the aqueous solution.

With regard to the invention, the following should be stated specifically:

By means of the process according to the invention, an aqueous solution of homo- or copolymers of acrylic acid is prepared by polymerization in an aqueous medium.

The term “aqueous solution” or “aqueous medium” in the context of this invention is intended to mean that the solvents used are essentially water. This does not rule out the presence of small amounts of other water-miscible solvents. Further solvents may, for example, be alcohols such as methanol, ethanol or propanol. However, the amount of water should generally be at least 80% by weight, preferably at least 90% by weight and more preferably at least 95% by weight, based on the sum of all solvents together. More preferably, the solvent used is exclusively water. However, this procedure does not rule out that small amounts of alcohols may nevertheless be present in the aqueous medium after the polymerization owing to side reactions.

The concentration of the homo- or copolymer in the aqueous solution is typically from 20 to 60% by weight based on all constituents of the aqueous solution, preferably from 30 to 55% by weight and more preferably from 35 to 52% by weight.

According to the invention, in addition to acrylic acid, further water-soluble monoethylenically unsaturated comonomers (C) may optionally be used to synthesize the polymers, in which case the amount of acrylic acid is at least 80% by weight based on the sum of all monomers together, preferably at least 90% by weight, more preferably 95% by weight, and very particular preference is given to using exclusively acrylic acid as the monomer.

The use of comonomers allows the properties of the acrylic acid polymers to be altered. Examples of suitable monoethylenically unsaturated comonomers (C) comprise other monomers with acidic groups, for example methacrylic acid, crotonic acid, maleic acid, itaconic acid, vinylphosphonic acid, vinylsulfonic acid, 2-acrylamido-2-methylpropanesulfonic acid, water-soluble (meth)acrylic acid derivatives, for example hydroxyethyl acrylate, hydroxypropyl acrylate, hydroxybutyl acrylate, (meth)acrylamide, vinylformamide, alkali metal (3-methacryloyloxy)propanesulfonate, dimethylaminoethyl acrylate, 2-acryloyloxyethyltrimethylammonium chloride, dimethylaminomethacrylate or polyethylene glycol methyl ether (meth)acrylate.

Preferred comonomers (C) are—if present at all—maleic acid and methacrylic acid.

The acrylic acid homo- or copolymers are prepared by means of controlled free-radical polymerization in the presence of a sulfur-containing assistant (H) to control the reaction. Such assistants are frequently also referred to as RAFT reagent.

According to the invention, the assistant (H) is an unsymmetric molecule of the general formula R¹—X—C(S)—S—CR²ₙ(COOR³)ₘ (I).

In formula (I), X here is O or S; the molecules are thus either derivatives of trithiocarbonic acid or of dithiocarbonic acid. The latter are also referred to as xanthogenates. X is preferably O; the molecules are thus preferably xanthogenates.

The R¹ radical is a radical selected from the group of R^{1a}, R^{1b} and R^{1c} radicals.

The R^{1a} radicals are alkyl radicals selected from the group of methyl, ethyl, 1-propyl, 1-butyl and 2-methyl-1-propyl radicals. The carbon atom bonded directly to X is thus connected to a maximum of one further carbon atom. R^{1a} is preferably linear alkyl radicals selected from the group of methyl, ethyl, 1-propyl, 1-butyl radicals, and R^{1a} is more preferably methyl or ethyl radicals.

The R^{1b} radicals are radicals which have carboxyl groups or carboxylate groups and are of the general formula R³OOC—(CH₂)ₒ— where o is a natural number from 1 to 4, preferably from 1 to 3. R³ is independently H, a cation, methyl or ethyl. Cations have the general formula 1/m M^{m+} where m is 1, 2 or 3, preferably 1 or 2 and more preferably 1. Useful cations are especially alkali metal ions, ammonium ions and alkaline earth metal ions. Preference is given to alkali metal ions, especially Na⁺, and ammonium ions, for example NH₄+ or alkylammonium or hydroxyalkylammonium ions. R³ is preferably H or a methyl group.

The R^{1c} radicals are alkoxy radicals of the general formula R⁴—[—O—CH₂—CH₂]ₖ— where R⁴ is H or a straight-chain or branched alkyl radical having from 1 to 4 carbon atoms, and k is from 1 to 10. R⁴ is preferably H or methyl, and k is preferably from 1 to 5, more preferably from 1 to 3. The person skilled in the art is aware that such radicals can be prepared by alkoxylation, which leads to a random distribution of the chain lengths, and that the chain lengths reported should therefore be considered as mean values.

The carbon atom bonded to a sulfur atom has n R² substituents and m —COOR³ substituents, where n and m are each independently 1 or 2, and the sum of n+m=3.

The n R² radicals are each independently H or a straight-chain or branched alkyl radical having from 1 to 4 carbon atoms, for example methyl, ethyl, 1-propyl, 2-propyl, 1-butyl or 2-butyl radicals, with the proviso that not more than one R² radical is H. R² is preferably H, methyl or ethyl, and more preferably H or methyl. The R³ radicals are each as defined above.

In a preferred embodiment of the process according to the invention, the assistant (H) has the general formula R¹—O—C(S)—S—CR²ₙ(COOR³)ₘ (II), i.e. the assistant is a xanthogenate.

In a particularly preferred embodiment, the assistant (H) is a xanthogenate which has the general formula R¹—O—C(S)—S—CH(CH₃)(COOR³) (III), where R¹ in formula (III) is preferably an R^{1a} or R^{1c} radical.

Examples of preferred assistants of the formula (III) comprise
H₅C₂—O—C(S)—S—CH(CH₃)(COOH),
H₅C₂—O—C(S)—S—CH(CH₃)(COOCH₃),
H₅C₂—O—C(S)—S—CH(CH₃)(COOC₂H₅),
H₃C—O—CH₂—CH₂—O—C(S)—S—CH(CH₃)(COOH),
H₃C—O—CH₂—CH₂—O—C(S)—S—CH(CH₃)(COOCH₃),
H₃C—O—CH₂—CH₂—O—C(S)—S—CH(CH₃)(COOC₂H₅),
H₅C₂—O—C(S)—S—C(CH₃)(COOC₂H₅)₂,
H₅C₂—O—C(S)—S—C(CH₃)(COOCH₃)₂,
H₅C₂—O—C(S)—S—C(CH₃)(COOH)₂,
H₃C—O—CH₂—CH₂—O—C(S)—S—C(CH₃)(COOC₂H₅)₂,
H₃C—O—CH₂—CH₂—O—C(S)—S—C(CH₃)(COOCH₃)₂, and
H₃C—O—CH₂—CH₂—O—C(S)—S—C(CH₃)(COOH)₂.

Very particularly preferred assistants are H₅C₂—O—C(S)—S—CH(CH₃)(COOH) and H₅C₂—O—C(S)—S—CH(CH₃)(COOCH₃).

In a further particularly preferred embodiment, the assistant (H) is a trithiocarbonate which has the general formula R¹—S—C(S)—S—CH(CH₃)(COOR³) (IV), and where R¹ in formula (IV) is preferably an R^{1a} or R^{1b} radical.

Examples of preferred assistants of the formula (IV) comprise
H₅C₂—S—C(S)—S—CH(CH₃)(COOC₂H₅),
H₅C₂—S—C(S)—S—CH(CH₃)(COOCH₃),
H₅C₂—S—C(S)—S—CH(CH₃)(COOH),
H₃C—(CH₂)₃—S—C(S)—S—CH(CH₃)(COOC₂H₅),
H₃C—(CH₂)₃—S—C(S)—S—CH(CH₃)(COOCH₃),
H₃C—(CH₂)₃—S—C(S)—S—CH(CH₃)(COOH),
HOOC—CH₂—CH₂—S—C(S)—S—CH(CH₃)(COOH),
H₃COOC—CH₂—CH₂—S—C(S)—S—CH(CH₃)(COOCH₃) or
H₃COOC—CH₂—CH₂—S—C(S)—S—CH(CH₃)(COOC₂H₅).

Very particular preference is given to H₃C—(CH₂)₃—S—C(S)—S—CH(CH₃)(COOCH₃) and H₃C—(CH₂)₃—S—C(S)—S—CH(CH₃)(COOH).

The assistants described can be prepared by methods known in principle to those skilled in the art. For example, an alcohol or thiol R¹—XH, CS₂ and a bromide Br—CR²ₙ(COOR³)ₘ can be reacted with one another. Preferably, in a first stage, CS₂ can be reacted with R¹—XH, and the resulting acid can be neutralized with KOH. The resulting salt R¹—X—C(═S)—SK, for example potassium ethylxanthogenate H₅C₂—O—C(═S)—SK, can then be reacted in a second stage with the bromide specified, for example Br—CH(CH₃)—COOH. Potassium ethylxanthogenate is commercially available.

It is of course also possible to use mixtures of two or more assistants [H].

The assistants (H) described are comparatively hydrophilic dissolve at least partially in water or water-acrylic acid mixtures. To perform the process according to the invention, the sulfur-containing assistant (H) is first initially charged as an aqueous solution or dispersion. The terms “aqueous” and “aqueous medium” have been defined at the outset. Optionally, it is also possible to add additives to improve the solubility of the assistant (H), but preference is given to working without any such additives.

It is clear to the person skilled in the art that carboxylic ester groups can be hydrolyzed in acidic aqueous medium. This has the consequence that, even when the assistants (H) are used in the form of esters thereof, at least a portion of the assistant is present after a certain time as the free carboxylic acid or—according to the pH of the medium—as a salt thereof. In addition, as a consequence of the hydrolysis, alcohols are released from the ester group, and so the aqueous medium in this case comprises small amounts of alcohol, even if no alcohol at all has originally been used as a solvent.

The polymerization is performed in a temperature-controllable reaction vessel. Apparatus suitable for performing the polymerization is known in principle to those skilled in the art. The apparatus may, for example, be stirred tanks which possess an appropriate number of addition apparatuses for metering in the individual components, especially for continuous addition of the monomers and if appropriate of the initiator, and also means of inertization and of controlling the temperature.

To perform the process according to the invention, in a first process step, an aqueous solution or dispersion of the sulfur-containing assistant (H) is initially charged in the temperature-controllable reaction vessel.

In the process according to the invention, the total amount of the aqueous medium used is such that, after performance of the process, the concentration of the homo- or copolymer in the aqueous medium is preferably from 20 to 60% by weight based on all constituents of the aqueous solution, preferably from 30 to 55% by weight and more preferably from 35 to 52% by weight. In this way, ready-to-use solutions are obtained directly.

According to this proviso, not more than the total amount of the aqueous medium required is used when the sulfur-containing assistant (H) is initially charged in aqueous medium. In general, however, the amount of water chosen by the person skilled in the art is lower, because it is generally advisable to dissolve at least the initiator in an aqueous medium before it is added and to add it in dissolved form. In general, at least 50%, preferably at least 60% and more preferably at least 75% of the total amount of aqueous medium should be initially charged. It has been found to be advisable to use the assistant in a concentration of not more than 75 mmol/l, preferably not more than 60 mmol/l, without any intention that this should restrict the invention to these values.

In the next process step, the initially charged solution or dispersion—if required—is heated to the desired polymerization temperature of from 20 to 100° C. This temperature range ensures that the polymerization can be conducted at ambient pressure. It is of course possible to alter the polymerization temperature in the course of the process, i.e., for example, to increase it stepwise. The polymerization temperature is preferably from 50 to 95° C. and more preferably from 60 to 90° C.

For the polymerization, the initiator, the acrylic acid and any further comonomers (C) are added to the initially charged solution or dispersion of the assistant in aqueous medium. According to the invention, the components are added continuously, i.e. the total amount of the components is not added all at once, but the addition is effected gradually in the course of the reaction time. Completion of addition may, if appropriate, be followed by a certain postreaction time.

The acrylic acid is liquid and is preferably metered in in pure form. However, it can of course also be used in the form of an aqueous solution. The term “acrylic acid” here shall comprise both free acrylic acid and salts of acrylic acid, for example alkali metal, alkaline earth metal or ammonium salts. Salts can preferably be used as an aqueous solution.

If comonomers (C) are used, they can be mixed with the acrylic acid or preferably added by means of a separate feed. According to the properties of further monomers, they may be used in pure form or as an aqueous solution.

The initiator (In) is a water-soluble initiator having azo groups for thermal polymerization. It is preferably used in the form of a solution in aqueous medium and is added continuously in parallel or at least essentially in parallel to the addition of the acrylic acid or further comonomers. “Essentially in parallel” is intended to mean here that the monomers or the initiator may have a certain preliminary or subsequent run time compared to the other components in each case, that at least 50 mol %, preferably 80 mol % and more preferably at least 90 mol % of the initiator and of the monomers are metered simultaneously into the reaction vessel. The parallel continuous addition of the components also continuously generates the heat of reaction, and the temperature in the reaction vessel can easily be kept constant.

Water-soluble initiators having azo groups are known in principle to those skilled in the art, and the person skilled in the art makes a suitable selection. In doing so, he or she pays particular attention to the fact that the initiator used has a thermal stability matched to the desired polymerization temperature. The thermal stability of initiators is typically reported by the temperature of the 10 h halflife 10 h t_{1/2}, i.e. that temperature at which 50% of the original amount of initiator decomposes to free radicals within 10 h. To perform the process according to the invention, it is possible with preference to use initiators with a 10 h t_{1/2}, of from 40 to 90° C., preferably from 50 to 70° C.

Examples of suitable initiators comprise 2,2′-azobis[2-(2-imidazolin-2-yl)propane]dihydrochloride (10 h t_{1/2}: 44° C.), 2,2′-azobis[2-(2-imidazolin-2-yl(propane]disulfate dihydrate (10 h t_{1/2}: 47° C.), 2,2′-azobis(2-methylpropionamidine)dihydrochloride (10 h t_{1/2}: 56° C.), 2,2′-azobis[N-(2-carboxyethyl)-2-methylpropionamidine]hydrate (10 h t_{1/2}: 57° C.), 2,2′-azobis{2-[1-(2-hydroxyethyl)-2-imidazolin-2-yl]propane}dihydrochloride (10 h t_{1/2}: 60° C.), 4,4′-azobis(4-cyanopentanoic acid) (10 h t_{1/2}: 60° C.), 2,2′-azobis(1-imino-1-pyrrolidino-2-ethylpropane)dihydrochloride (10 h t_{1/2}: 67° C.), 4-(t-butylazo)-4-cyanopentanoic acid (10 h t_{1/2}: 73° C.), 2,2′-azobis{2-methyl-N-[1,1-bis(hydroxymethyl)-2-hydroxyethyl]propionamide} (10 h t_{1/2}: 80° C.) or 2,2′-azobis[2-methyl-N-(2-hydroxyethyl)propionamide] (10 h t_{1/2}: 87° C.).

For performance of the invention, particular preference is given to 2,2′-azobis(2-methylpropionamidine)dihydrochloride.

According to the invention, the molar ratio of the amount of the initiator used to the amount of the assistant used [In]/[H] is from 1:1 to 1:100, preferably from 1:2 to 1:50 and more preferably from 1:3 to 1:20.

The molar ratio of the amount of the monomers used to the amount of the assistant used [monomers]/[H] is from 5:1 to 150:1, preferably from 10:1 to 100:1, more preferably from 20:1 to 60:1 and most preferably from 30:1 to 50:1.

The polymerization is conducted up to a conversion of at least 99% based on the monomers used.

The polymerization can preferably be undertaken in strongly acidic medium by using pure acrylic acid for the synthesis. The polymerization can also be undertaken in less strongly acidic, slightly acidic, neutral or slightly alkaline medium. However, too high a pH should be avoided here, since there is otherwise the risk that the sulfur-containing assistants might hydrolyze and thus become inactive. The pH in the course of the reaction should preferably not exceed pH 7, more preferably pH 5 and most preferably pH 2. The pH can be established by adding a base, for example NaOH. The base should generally not be initially charged with the sulfur-containing assistant (H) in order to prevent the hydrolysis which has already been mentioned, but should be added continuously in the course of the reaction, preferably as an aqueous solution. Alternatively, the acrylic acid to be added can be used completely or partially in the form of salts thereof.

The number-average molar mass Mₙ of the homo- or copolymer of acrylic acid obtained by the process according to the invention is from 500 g/mol to 10 000 g/mol, preferably from 1000 g/mol to 8000 g/mol, more preferably from 2000 g/mol to 5000 g/mol and most preferably from 3000 to 4000 g/mol.

The polydispersity of the homo- or copolymers of acrylic acid obtained by means of the process, M_{w}/Mₙ, is, in accordance with the invention, less than 2; preferably, M_{w}/Mₙ<1.8 and more preferably <1.6.

The assistants (H) used to control the free-radical polymerization are incorporated into the polymer in stoichiometric amounts in the RAFT polymerization, such that every polymer chain comprises the assistant (H) or at least fragments thereof. Accordingly, the lower the mean molecular weight of the polymer, the higher the proportion of the assistant (H) in the polymer. While the influence of the assistant on the properties of the polymer can usually be neglected at high molecular weights, the influence of the assistant usually cannot be neglected at low molecular weights.

By means of the process according to the invention, comparatively low molecular weight homo- or copolymers of acrylic acid are synthesized. The ratio of monomers to the assistant [monomers]/[H] is, in accordance with the invention, from only 5:1 to 150:1. The polymers thus comprise comparatively high amounts of the sulfur-containing assistant. The comparatively low molecular weight polymers obtained after the polymerization therefore have a clearly perceptible, extremely undesired odor. Moreover, the polymers have a slight, likewise undesired color.

After the polymerization, the assistants (H) incorporated into the homo- or copolymer of the acrylic acid are therefore deactivated by means of suitable measures in a further process step.

The term “deactivation” in the context of this invention means that the assistants or fragments of the assistants incorporated into the polymer are eliminated completely or partially or—without being eliminated—are altered by means of suitable chemical reactions such that no adverse product properties emanate from them any more, especially such that no undesired odor and/or no undesired discoloration emanates from the acrylic acid polymers any longer.

Methods for deactivation have already been mentioned at the outset, for example the methods disclosed by US 2003/166790, US 2004/122193 or US 2007/0027266. However, not all methods are suitable for use in aqueous solution.

In a preferred embodiment of the invention, the deactivation is undertaken by hydrolysis using a base. The base may be an alkali metal base, for example NaOH or KOH, or else it is possible to use ammonia or amines. The reaction can be undertaken by, on completion of the polymerization reaction of the aqueous solution, adding the desired base and heating the solution. The temperature in the course of the hydrolysis is preferably from 50 to 100° C., and base should preferably be used in such an amount that the pH is at least 7.

In a preferred embodiment of the invention, the deactivation of the assistant is undertaken using an oxidizing agent. Useful oxidizing agents include especially iodine, sodium hypochlorite or peroxides, for example hydrogen peroxide or organic peroxides. The deactivation can be undertaken by adding an aqueous peroxide solution, especially an aqueous H₂O₂ solution, on completion of the polymerization reaction of the aqueous solution, and heating the solution. In this case, the sulfur present in the assistant is oxidized to sulfur in higher oxidation states, for example to sulfate. Sulfate formed can preferably be precipitated out of the polymer solution using suitable assistants, for example barium hydroxide.

In a further preferred embodiment of the invention, the deactivation of the assistant is undertaken using a reducing agent. A useful reducing agent is especially ascorbic acid.

In a further preferred embodiment of the invention, the deactivation of the assistant is undertaken using a free-radical initiator with a hydrogen donor. Useful free-radical initiators include especially organic peroxides, for example lauryl peroxide. Useful hydrogen donors include secondary and tertiary alcohols, toluene and hypophosphorous acid.

In the deactivation, the particular advantages of the specific assistants (H) for polymerization of acrylic acid become apparent. The assistants can be deactivated without this resulting in degradation of the polymers or in an increase in the polydispersity of the polymer M_{w}/Mₙ.

The homo- or copolymers of acrylic acid obtained by the process according to the invention are suitable very particularly for dispersion of pigments, especially for dispersion or grinding of inorganic pigments, for example calcium carbonate, kaolin, titanium dioxide, zinc oxide, zirconium oxide, aluminum oxide, especially for dispersing ground calcium carbonate (GCC). The aim is the preparation of aqueous suspensions of the pigments mentioned (pigment slurries).

For this purpose, the polyacrylic acid solution is preferably used in partly neutralized form, such that the pH of the solution used is about 5.

For the dispersion or grinding of pigments—particularly inorganic pigments—anionic dispersants based on polyacrylic acid and salts thereof are used.

The polymers prepared in accordance with the invention are particularly suitable for demanding calcium carbonate slurries which have a solids content of at least 70% by weight and a particle size of 95% smaller than 2 μm and 75% smaller than 1 μm. The use of the polyacrylic acid prepared in accordance with the invention allows the dispersion or grinding to be particularly energy-efficient, and a homogeneous size distribution of the pigments can be achieved. In addition, the grinding time can be reduced and the resulting suspension has a low viscosity. Moreover, the pigment slurry remains stable over the long term, i.e. the rise in viscosity with time is relatively low. The person skilled in the art is aware of suitable apparatus for dispersion or grinding of inorganic pigments.

The examples which follow are intended to further illustrate the invention:

### Analysis Methods:

In each case, the conversion, the mean molar mass Mₙ and the polydispersity M_{w}/Mₙ of the resulting polyacrylic acid solutions were determined.

The conversion was determined in each case by ¹H NMR in D₂O.

The mean molar mass Mₙ and the polydispersity M_{w}/Mₙ were each determined by means of gel permeation chromatography (GPC). The GPC calibration was effected with polyacrylic acid (sodium salt) of known distribution as a standard. Eluent: a mixture of 0.08 mol/l of TRIS buffer pH=7.0 in distilled water, 0.15 mol/l of NaCl and 0.01 mol/l of NaN₃.

### EXAMPLES 1 to 4

### Polymerization of Acrylic Acid with Unsymmetric Hydrophilic Raft Reagents

### General Experimental Method:

The polymerization was undertaken in a 1 liter flask with a cold trap and gas inlet. The flask additionally displayed a feed for acrylic acid and a feed for the initiator.

0.18 mol of the particular RAFT reagent (see table 1) was dissolved or suspended in 450 ml of water. The mixture was heated to 70° C. with continuous introduction of nitrogen and stirring. 450 g (6.25 mol) of acrylic acid were continuously added dropwise to the mixture within 4 hours, as were, in parallel, 4.9 g (18 mmol) of 2,2′-azobis(2-methylpropionamidine) dihydrochloride (10 h t_{1/2}: 56° C.) dissolved in 40 ml of water within 4.5 hours. After the addition had ended, the mixture was cooled to room temperature and analyzed as described above. The RAFT reagents used in each case and the analysis results are compiled in table 1.

### EXAMPLE 5

### Polymerization of Acrylic Acid with Unsymmetric Hydrophilic Raft Reagents with In Situ Preparation of the Raft Reagent

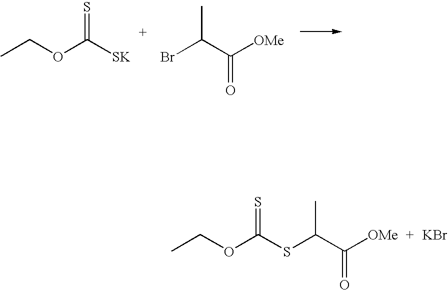

The reaction was carried out in the apparatus according to example 1.

30 mmol of potassium ethylxanthogenate and 30 mmol of methyl bromopropionate were stirred in 200 ml of water in a 1 liter flask. The mixture was heated to 70° C. with continuous introduction of nitrogen and stirring. After 3 hours, 1 mol of acrylic acid was added dropwise. In addition, 0.81 g (3 mmol) of 2,2′-azobis(2-methylpropionamidine) dihydrochloride dissolved in 10 ml of water was added dropwise within 2 hours. After the addition had ended, the mixture was cooled to room temperature and analyzed as described above.

### COMPARATIVE EXAMPLE 1

The procedure was as described in examples 1 to 4, except that a significantly more hydrophobic RAFT reagent was used.

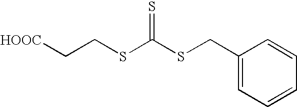

The analysis results are compiled in table 1.

### EXAMPLE 6

### Inventive Polymerization with Deactivation of the Raft Reagent by Means of Alkaline Hydrolysis

The experiment was carried out in the apparatus according to example 1. The following RAFT reagent was used:

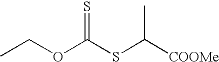

0.15 mol of the RAFT reagent was dissolved or suspended in 380 ml of water in a. The mixture was heated to 70° C. while continuously introducing nitrogen and stirring. 360 g (5 mol) of acrylic acid were continuously added dropwise to the mixture within 2 hours, as were, in parallel, 4.1 g (15 mmol) of 2,2′-azobis(2-methylpropionamidine) dihydrochloride dissolved in 100 ml of water within 2.25 hours. After the addition had ended, 5 ml of sample were taken and analyzed as described above. The pH of the solution is 1.8. The odor of the solution is unpleasantly sulfurous.

The pH of the remaining solution was subsequently alkalized with 430 g of 50% NaOH solution, and the resulting solution was stirred at 70° C. for 1 hour. The pH of the solution was 14. The mixture was cooled to room temperature and analyzed as described above. The solution is odorless. The results are compiled in table 2.

### EXAMPLE 7

### Inventive Polymerization with Oxidative Deactivation of the Raft Reagent

The polymerization was performed as in example 6. The deactivation of the RAFT reagent was undertaken as follows.

102 g of 50% H₂O₂ solution were added dropwise within 5 hours at 90° C. to the resulting polyacrylic acid solution which was stirred for another 2 hours. The mixture was cooled to room temperature and analyzed as described above. The results are compiled in table 2. The pH of the solution is 0.5. The sulfurous odor is no longer discernible.

### COMPARATIVE EXAMPLE 2

### Polymerization of Acrylic Acid with Symmetric Hydrophilic Raft Reagents with Deactivation of the RAFT Reagent by Means of Alkaline Hydrolysis

The experiment was carried out in the apparatus according to example 1. The following RAFT reagent was used:

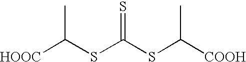

3 mmol of the RAFT reagent were dissolved or suspended in 120 ml of water in a. The mixture was heated to 70° C. with continuous introduction of nitrogen and stirring. 21.6 g (0.3 mol) of acrylic acid were added dropwise to the mixture, as were, in parallel, 0.81 g (0.3 mmol) of 2,2′-azobis(2-methylpropionamidine) dihydrochloride dissolved in 5 ml of water within 2 hours. The mixture was stirred for a further 1 h. After the addition had ended, 5 ml of sample were taken and analyzed as described above.

The remaining solution was subsequently neutralized with 30 g of 50% NaOH solution and stirred at 70° C. for 1 hour. The mixture was cooled to room temperature and analyzed as described above. The results are compiled in table 2.

### COMPARATIVE EXAMPLE 3

### Polymerization of Acrylic Acid with Symmetric Hydrophilic Raft Reagents with Oxidative Deactivation of the RAFT Reagent

The same RAFT reagent as in comparative example 2 was used.

The polymerization was undertaken in a 4 liter flask with a cold trap and gas inlet. The flask additionally displayed a feed for acrylic acid and a feed for the initiator.

75 mmol of the RAFT reagent were suspended in 1000 ml of water. The mixture was heated to 70° C. with continuous introduction of nitrogen and stirring. 216 g (3 mol) of acrylic acid were continuously added dropwise to the mixture, as were, in parallel, 20.3 g (7.5 mmol) of 2,2′-azobis(2-methylpropionamidine) dihydrochloride dissolved in 100 ml of water within 2 hours. The mixture was stirred for a further 1 h. After the addition had ended, 5 ml of sample were taken and analyzed as described above.

The remaining solution was concentrated to 50%, then 22 ml of 50% H₂O₂ solution were added dropwise at 60° C. within 2 hours and the solution was stirred for another 30 min. The mixture was cooled to room temperature and analyzed as described above. The results are complied in table 2.

The examples and comparative examples show that, when symmetric assistants (H) are used, when the assistant is eliminated after the reaction has ended, there is simultaneously a considerable decrease in the molecular weight of the polyacrylic acid by from 30 to 40% (see comparative example 2 and comparative example 3). Unsymmetric but excessively hydrophobic assistants (H) lead to a wide molecular weight distribution (see comparative example 1). Only the unsymmetric and hydrophilic assistants (H) used in accordance with the invention lead to a molecular weight distribution M_{w}/Mₙ<2 without there being any partial degradation of the polyacrylic acid when the assistant is eliminated after the reaction.

TABLE 1
Compilation of the examples and comparative examples

| | | | Molar | | | | | |
|---|---|---|---|---|---|---|---|---|
| | | Molar | acrylic | Polyacrylic | | | | |
| | | initiator/ | acid/ | acid | | | | |
| | Assistant | assistant | assistant | concentration | Mn | | | |
| No. | (RAFT reagent) | ratio | ratio | [% by weight] | [g/mol] | Mw/Mn | Conversion | Notes |
| Example 1 | 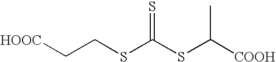 | 1:10 | 35:1 | 51 | 4200 | 1.3 | 99.5 | |
| Example 2 | 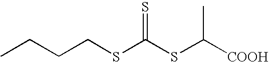 | 1:10 | 35:1 | 50 | 3600 | 1.3 | 99.5 | |
| Example 3 | 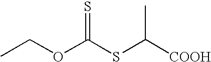 | 1:10 | 35:1 | 50 | 3900 | 1.6 | 99.9 | |
| Example 4 | 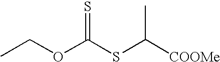 | 1:10 | 35:1 | 50 | 3700 | 1.5 | 99.9 | |
| Example 5 | 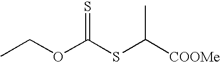 | 1:10 | 33:1 | 27 | 4200 | 1.6 | 99.9 | RAFT reagent was prepared in situ |
| C1 | 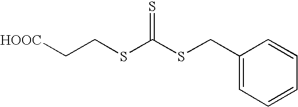 | 1:10 | 35:1 | 50 | 8500 | 2.3 | 99.5 | |

TABLE 2
Compilation of the examples and comparative examples

| | | | Molar | | | | After the deactivation | | |
|---|---|---|---|---|---|---|---|---|---|
| | | Molar | acrylic | | After | | | | Polyacrylic |
| | | initiator/ | acid/ | | polymerization | | | | acid |
| | Assistant | assistant | assistant | Conversion | Mn | | Mn | | concentration |
| No. | (RAFT reagent) | ratio | ratio | [%] | [g/mol] | Mw/Mn | [g/mol] | Mw/Mn | [% by weight] |
| Example 6 | 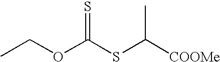 | 1:10 | 33:1 | 99.9 | 3500 | 1.5 | 3600 | 1.5 | 40 |
| Example 7 | 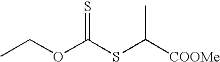 | 1:10 | 33:1 | 99.5 | 3400 | 1.5 | 3500 | 1.5 | 45 |
| C2 | 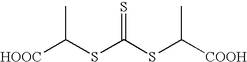 | 1:10 | 100:1 | 99.5 | 9700 | 1.2 | 6800 | 1.4 | 13 |
| C3 | 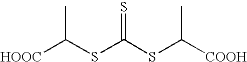 | 1:10 | 40:1 | 99.5 | 4200 | 1.1 | 2500 | 1.4 | 50 |

1. A process for preparing aqueous solutions of homo- or copolymers of acrylic acid by means of controlled free-radical polymerization of acrylic acid and optionally water-soluble monoethylenically unsaturated comonomers (C) in an aqueous medium in the presence of a sulfur-containing assistant (H) for control of the reaction, where
the amount of acrylic acid is at least 80% by weight based on the sum of all monomers together,
the number-average molar mass Mₙ of the homo- or copolymer is from 500 g/mol to 10 000 g/mol,
the polydispersity of the homo- or copolymer M_{w}/Mₙ is <2,
the concentration of the homo- or copolymer is from 20 to 60% by weight based on all constituents of the aqueous solution, and
the polymerization temperature is from 20 to 100° C.,
wherein the assistant H is an unsymmetric molecule of the general formula (I) R¹—X—C(S)—S—CR²ₙ(COOR³)ₘ (I), and where the radicals and the indices are each defined as follows:
n, m: each independently 1 or 2, where n+m=3,
X: O or S,
R¹: a radical selected from the group of
R^{1a} alkyl radicals selected from the group of methyl, ethyl, 1-propyl, 1-butyl and 2-methyl-1-propyl,
R^{1b} radicals of the general formula R³OOC—(CH₂)ₒ— where o is a natural number from 1 to 4, or
R^{1c} alkoxy radicals of the general formula R⁴—[—O—CH₂—CH₂]ₖ— where R⁴ is H or a straight-chain or branched alkyl radical having from 1 to 4 carbon atoms and k is from 1 to 10,
R²: each independently H or an alkyl radical having from 1 to 4 carbon atoms, with the proviso that not more than one R² radical is H,
R³: each independently H, a cation, methyl or ethyl,
and the process comprises the following steps:
initially charging an aqueous solution or dispersion of the sulfur-containing assistant (H) in a temperature-controllable reaction vessel,
heating to the desired reaction temperature,
continuously adding a water-soluble initiator having azo groups for the thermal polymerization (In), the molar ratio of the total amount of the initiator (In) to the assistant [In]/[H] being from 1:1 to 1:100,
continuously adding acrylic acid or salts thereof and optionally further comonomers (C) or an aqueous solution of the monomers mentioned, the molar ratio of the monomers to the assistant [monomers]/[H] being from 5:1 to 150:1, and
deactivating the assistant (H) bonded to the acrylic acid homo- or copolymer formed, with the proviso that the polymerization is conducted up to a conversion of at least 99%, and that the total amount of the aqueous medium used is such that, after the process has been performed, the concentration of the homo- or copolymer is from 20 to 60% by weight based on all constituents of the aqueous solution.

2. The process according to claim 1, wherein the assistant (H) has the general formula (II) R¹—O—C(S)—S—CR²ₙ(COOR³)ₘ.

3. The process according to claim 2, wherein the assistant (H) has the general formula (III) R¹—O—C(S)—S—CH(CH₃)(COOR³), and R′ is an R^{1a} or R^{1c} radical.

4. The process according to claim 1, wherein the assistant (H) has the general formula (IV) R¹—S—C(S)—S—CH(CH₃)(COOR³), and R¹ is an R^{1a} or R^{1b} radical.

5. The process according to claim 1, that the monomer used is exclusively acrylic acid.

6. The process according to claim 1, wherein the polymerization temperature is from 50 to 95° C.

7. The process according to claim 1, wherein the temperature of the 10 h halflife 10 h t_{1/2} of the initiator used is from 40 to 90° C.

8. The process according to claim 1, wherein the molar ratio of the monomers to the assistant [monomers]/[H] is from 10:1 to 100:1.

9. The process according to claim 1, wherein the molar ratio of the initiator to the assistant [In]/[H] is from 1:3 to 1:20.

10. The process according to claim 1, wherein the number-average molar mass Mₙ of the homo- or copolymer is from 2000 g/mol to 5000 g/mol.

11. The process according to claim 1, that the deactivation of the assistant is undertaken using an oxidizing agent.

12. The process according to claim 11, wherein sulfate formed in the oxidation is removed from the aqueous solution using a suitable assistant.

13. The process according to claim 1, that the deactivation of the assistant is undertaken by hydrolysis using a base.

14. The process according to claim 2, that the monomer used is exclusively acrylic acid.

15. The process according to claim 3, that the monomer used is exclusively acrylic acid.

16. The process according to claim 4, that the monomer used is exclusively acrylic acid.

17. The process according to claim 2, wherein the polymerization temperature is from 50 to 95° C.

18. The process according to claim 3, wherein the polymerization temperature is from 50 to 95° C.

19. The process according to claim 4, wherein the polymerization temperature is from 50 to 95° C.

20. The process according to claim 5, wherein the polymerization temperature is from 50 to 95° C.
